(19) United States
(12) Patent Application Publication
(10) Pub. No.: US 2024/0428144 A1
(43) Pub. Date: Dec. 26, 2024

(54) A METHOD FOR BOOKING AN ELECTRICAL VEHICLE CHARGING STATION AND A METHOD OF MANAGING ELECTRICAL VEHICLE BATTERY CHARGING AT A COMMERCIAL PARKING LOCATION

(71) Applicant: GRID SMARTER CITIES, Newcastle Upon Tyne (GB)

(72) Inventor: Neil HERRON, Newcastle Upon Tyne (GB)

(21) Appl. No.: 18/707,392

(22) PCT Filed: Nov. 3, 2022
(86) PCT No.: PCT/GB2022/052771

§ 371 Date: May 3, 2024

(30) Foreign Application Priority Data
Nov. 4, 2021 (GB) 2115856.3
Jan. 21, 2022 (GB) 2200787.6

(51) Int. Cl. G06Q 10/02

(52) U.S. Cl. CPC G06Q 10/02

(57) ABSTRACT

Methods are disclosed for booking electrical vehicle charging stations and for managing electrical vehicle battery charging at such stations. The method includes determining the available charging the battery and determining what charges required in order to complete intended journeys. Only charging stations which can provide sufficient charge in the available time are offered and if an excess of charge is available then this can be sold back to the electrical distribution grid and the cost of parking reduced. Only charging stations which can provide sufficient charge in the available time are offered and if an excess of charge is available then this can be sold back to the electrical distribution grid and the cost of parking reduced or other offers made.

The present invention relates to a method for booking an electrical vehicle charging station and relates particularly, but not exclusively, to a method for managing journeys and bookings of electrical charging stations. It also relates to a method of managing electrical vehicle battery charging at a commercial parking location and relates particularly, but not exclusively, to a method for allowing charge to be supplied back to an electrical distribution network from a vehicle battery.

With the number of electric vehicles on the roads increasing every year the availability of electrical charging stations free for use diminishes. This is a circumstance due to the rate of new charging stations being added to the overall infrastructure not matching the need for non-domestic charging points.

With parking places already at a premium for users who drive petrol or diesel cars, a growing sense of “range anxiety” is being added to the frustrations of electric car users trying to find a suitable parking place.

In addition to increased traffic on today's roads, the average journey can be subject to detours and long delays. This can cause the charge on an electric vehicle to decrease past a level lower than the user had originally anticipated, further increasing the user's anxieties to quickly find a charging station.

The increasing fleet of vehicles which have batteries with significant charge stored therein offers a potential useful resource for grid balancing operations but this must be managed to ensure that the vehicles do not become stranded due to insufficient charge.

Preferred embodiments of the present invention seek to overcome or alleviate the above described disadvantages of the prior art.

According to an aspect of the present invention there is provided a method for booking an electrical charging station for an electric vehicle comprising the steps:
on a user interface a user selecting a first destination;
locating an electrical charging station in a vicinity of said first destination;
determining an estimated arrival time for an electric vehicle associate with said user at said charging station;
determining a duration for said vehicle to be charging at said charging station;
presenting to said user a first list of items representing said charging stations together with prices for use;
said user selecting an item to book a said charging station associated with said selected item;
determining a second destination;
estimating the remaining charge in said battery on arrival at said booked charging station;
evaluating the additional charge that could be supplied by the charging station to the vehicle over said duration;
calculating the total charge from the additional and remaining charges and determining whether the vehicle would have sufficient charge to travel to said second destination;
if the total charge is not sufficient presenting a second list of items representing said charging stations which can supply sufficient charge to the vehicle within the duration to power said vehicle to said second destination together with prices for use to said user; and
giving the user an option to alter the booked charging station.

With the number of electric vehicles on the roads increasing every year there is a necessity for charging stations to be properly managed. With a booking system in place for drivers to access and see which available charging stations are available a more organised infrastructure can be obtained. By further improving the infrastructure of public charging stations through the use of a booking system, driver anxieties that can result from a depleting battery charge are reduced. By decreasing the range anxiety of drivers and improving the ease of booking a charging station in public more people could be inclined to choose an electric vehicle or other alternatives.

In a preferred embodiment of the present invention where determining an estimated arrival time comprises at least one of user entering a destination and calculating the arrival time by receiving positional information of said electrical vehicle.

In another preferred embodiment of the present invention said method operates on a system in which said user operates a first computer device, said vehicle comprises a second computer device and a server comprises a third computer device.

In further preferred embodiment of the present invention determining the status of the battery comprises said first computer device receiving battery status information from said second computer device and transmitting data relating to said status information to said third computer device.

In another preferred embodiment of the present invention determining the second destination comprises at least one of the user entering a second destination and assuming a return journey as a default.

In a preferred embodiment of the present invention estimating the remaining charge in said battery on arrival at said charging station is estimated by subtracting from the charge in the battery an estimation of the charge required to get to said first destination.

According to another aspect of the present invention there is provided a method for booking an electrical charger for an electric vehicle comprising the steps:
on a user interface a user selecting a destination;
locating an electrical charging station in the vicinity of said destination;
determining an estimated arrival time for an electric vehicle associated with the user at said charging station;
presenting a list of items representing said charging stations together with prices for use to said user, wherein said list includes at least one item conditionally discounted by a third party; and
said user selecting an item to book said charging station.

By providing conditional discounts for charging stations, the advantage is provided that businesses have an opportunity to contact and advertise directly to customers who they know are intending to be in the vicinity of or visit their premises. In particular, businesses can offer discounts on the parking and charging in return for using (perhaps to a minimum value payment) their goods and/or services.

In a preferred embodiment, prior to presenting the list of items, the user is prompted to indicate the purpose of the trip they are undertaking.

By inputting the purpose of their trip, a user can get very targeted conditional offers to encourage them to engage with a particular business.

According to a further aspect of the present invention there is provided a method for booking an electrical charger for an electric vehicle comprising the steps:
on a user interface a user selecting a destination;
locating an electrical charging station in the vicinity of said destination;
determining an estimated arrival time for an electric vehicle associated with the user at said charging station;
presenting a list of items representing said charging stations together with prices for use to said user, wherein said list includes at least one item with an option for the user to purchase the use of the associated charging station or to bid on said use against other users; and
said user selecting whether to purchase or bid.

By selecting to bid on the use of a charging station a user can hope to pay less for the use of that station. However, by purchasing the use of a charging station a user can guarantee that the charging station will be free for them to use.

According to another aspect of the present invention there is provided a method of managing electrical vehicle battery charging at a commercial parking location, the method comprising:
determining at least one journey plan for an electrically powered vehicle with a battery including a parking event at a charging point;
using said journey plan to determine a charge required for said vehicle to complete said journey plan;
determining a charge available in said battery;
determining a minimum allowable charge for said battery;
using said charge required, said charge available and said minimum allowable charge to generate a profile for said vehicle;
communicating to a processor associated with said charging point said profile for said vehicle; and
adding charge to or drawing charge from the battery of the vehicle via said charging point dependent upon the profile.

By creating a profile: for a vehicle which is then communicated to the charging point, the advantage is provided that available charge in a battery vehicle can easily be determined based on the variables which together generate the profile. This ensures that grid balancing activities can be undertaken but without significantly risking the vehicle running out of charge during the course of the planned journeys.

In a preferred embodiment the journey plan is determined by input of at least one destination by a user.

In another preferred embodiment the journey plan is determined by analysis of previous journeys and travel patterns.

In a further preferred embodiment the journey plan includes a plurality of journeys to a plurality of charging stations.

The method may further comprise determining a driver identity for a driver of said vehicle and varying said minimum allowable charge dependent on said driver identity.

The method may also further comprise determining vehicle identification data and including said vehicle identification data in said profile.

According to a still further aspect of the present invention there is provided a method of managing electrical vehicle battery charging at a commercial parking location, the method comprising:
determining at least one journey plan including a journey from a charging point at a commercial parking location, where a cost for parking is payable, to a charging point at a variable cost charging location;
determining the charge required for making the or each journey;
determining the charge available in the vehicle;
varying the cost for parking in return for drawing some of the charge available in the vehicle.

By creating a profile for a vehicle which is then communicated to the charging point, the advantage is provided that available charge in a battery vehicle can easily be determined based on the variables which together generate the profile. This ensures that grid balancing activities can be undertaken but without significantly risking the vehicle running out of charge during the course of the planned journeys. Furthermore, providing an incentive for both vehicle driver and car park operator encourages participation in grid balancing activities which in turn has environmental benefits of reducing the need for extra carbon based fuel electricity generation.

The method may further comprise seeking confirmation from a user before varying the cost.

In a preferred embodiment the journey plan is determined by input of at least one destination by a user.

In another preferred embodiment the journey plan is determined by analysis of previous journeys and travel patterns.

In a further preferred embodiment the journey plan includes a plurality of journeys to a plurality of charging stations.

According to a further aspect of the present invention there is provided a method of managing electrical vehicle battery charging at a commercial parking location, the method comprising:
determining at least one journey plan for an electrically powered vehicle with a battery including a parking event at a charging point;
using said journey plan, together with other data, to generate a profile;
communicating to a processor associated with said charging point said profile for said vehicle; and
adding charge to or drawing charge from the battery of the vehicle dependent upon the profile.

Preferred embodiments of the present invention will now be described, by way of example only, and not in any limitative sense with reference to the accompanying drawings in which:

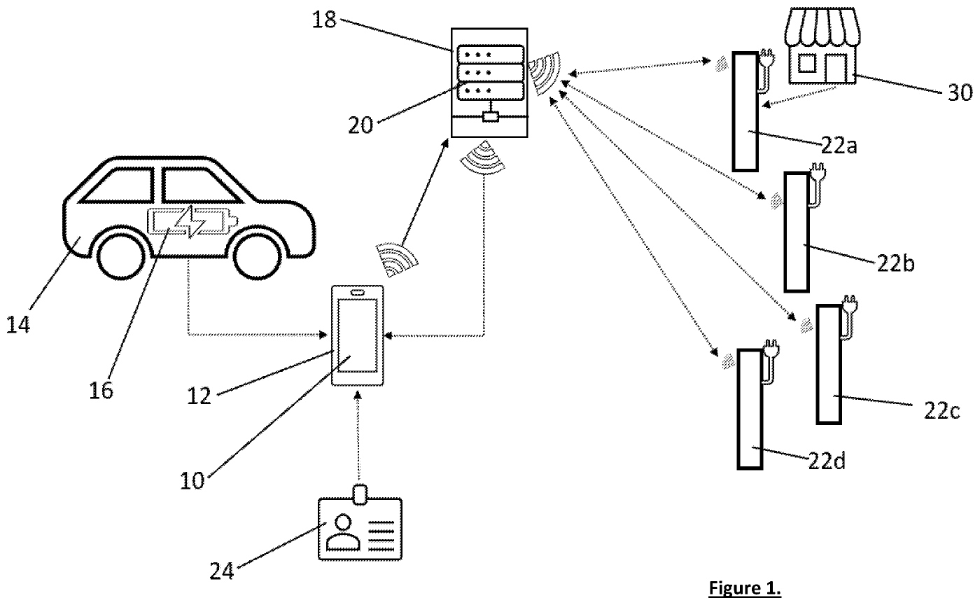

FIG. 1 is a schematic representation of the apparatus which is used in the booking system of the present invention;

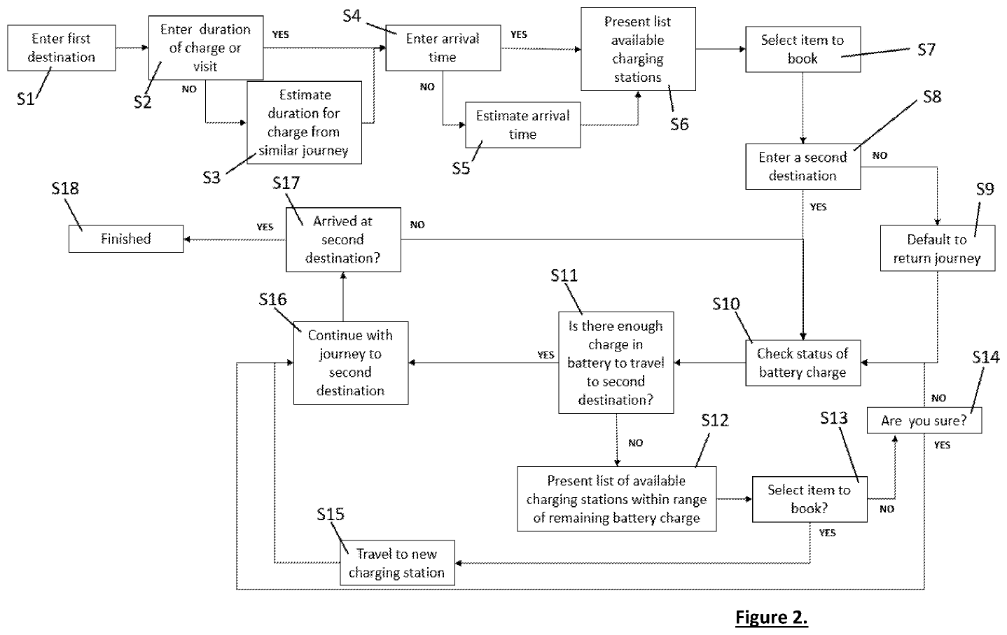

FIG. 2 is a flow diagram of the present invention;

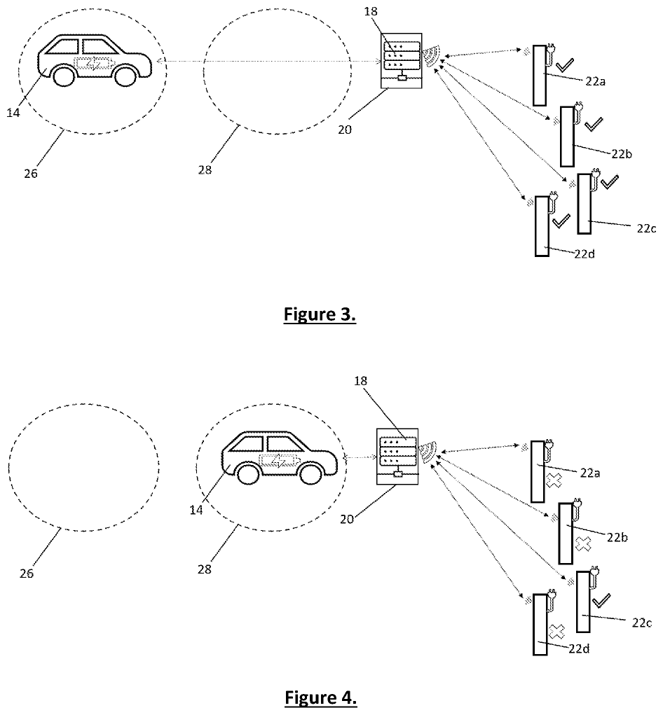

FIG. 3 is an example of a geofence boundary used in the method of the present invention; and

FIG. 4 is a further example of a geofence boundary used in the method of the present invention.

With initial reference to FIGS. 1 and 2, a method for booking an electrical charging station for an electric vehicle utilises a user interface 10 on a first computer device 12, an electric vehicle 14 (associated with a user) with a second computer device 16 and a central server 18 having a third computer device 20. A user, having a suitable first computer device 12 downloads the booking system program that provides the user interface 10 for the booking system. In this example the first computer is a mobile phone. However, it could be any suitable computer device including other mobile devices, in-vehicle devices or a device in a connected and autonomous vehicle (CAV) for example.

The program running on the user's device enables the user to access a register of charging stations 22a to 22d and available time slots for each station. Each charging station is situated adjacent a parking spot available to the user either immediately or at specified times. Once the program is downloaded the user can choose to login to access a customer profile 24 or register for one. The customer profile 24 includes a log of the users details such as previous destinations, their work and home journeys, frequently visited destinations, preferable charging networks, preferred charging times or whether they have chosen to enable location based services (LBS).

The steps used for booking an electrical charging station for an electric vehicle will now be described, with additional reference to FIGS. 3 and 4.

On the user interface 10, the user can login into their customer profile 24 or enter a first destination (step s1). If the user has chosen to login, the user can either choose a first destination from a previous entry or specify a new first destination. If the user chooses not to login they simply enter their first destination into the program. The first destination can be any location including but not limited to a specified point on a map (defined by selecting from a map displayed on the device 12 or by entering location coordinates), a publicly accessible location such as a shop, cinema or restaurant or a private address.

After this initial input from the user a signal is sent from the first computer device to the third computer device 20 at the central server 18, which checks the location of all the charging stations within the vicinity of the user's selected first destination. The definition of vicinity can be set in the user's profile. For example, the vicinity can be defined by the time it takes to walk from a charging station to the destination or a distance from the charging station to the destination. In this example the first destination is in the vicinity of charging stations 22a-22d.

Depending on the type of journey the user is undertaking they may also know the length of time they plan to stay at the first destination (step s2) and therefore the time that is available to charge the vehicle on arrival at the charging station that is in the vicinity of the first destination.

If a duration is not input and the user has logged into their customer profile 24, an estimate is made from their previous entries and charging or visiting times (step s3). For example, if the user is travelling to work and on average spends 8 hours at a booked charging station it would be reasonable for the first computer device 12 to assume this length of time. This could also be determined from a previous duration selected and saved on the user's customer profile 24. Similarly, an estimate of the duration can be made depending upon the destination selected. If a cinema is selected an estimate can be based on typical time taken to watch a film or a typical (average) duration of stay for other users who have selected the same destination.

The user is further asked to input an estimated arrival time at the first destination (step s4). If the arrival time is not entered an estimated arrival time is determined (step s5). This is calculated by the first computer device 12 transmitting the location of the vehicle to calculate a likely journey time to the first destination.

Once this information is received by the server 18 a list of charging stations is presented to the user (step s6). This list can contain a number of different charging station items and be limited according to the information the user has input typically through their user profile. The item variables include but are not limited to the type of charging station, the current status of the charging stations, distance from first destination, owner/operator of the charging station and price. The user can choose to select an item from the list at this stage or delay choosing until they are closer to their first destination (step s7).

In the instance that a user chooses to wait before booking a charging station, the location of the users vehicle 14 is continually transmitted to the server 18 and updates on the status of the charging stations is presented. FIG. 3 shows an example of how and when updates on the charging stations 22a-22d are received by the user. Once the user passes or breaches a first geofence boundary 260 a signal is sent to the server 18. The server checks the status of the charging stations 22a-22d and transmits to the user that currently all charging stations are available. The user could choose to book one of these stations immediately or further delay. FIG. 4 is an example of the user waiting and travelling closer to their destination. Once they have breached a second geofence boundary 28 another list of available stations is presented to the user. In this case only charging station 22c is available.

Once the user has chosen a first destination and has booked the associated charging station the user can proceed to input a second destination (step s8). This destination can be defaulted as their return journey (step s9) if they do not choose to input.

The input of the second destination is used to initiate a continual checking of the status of the vehicle's battery (step s10). This information is used, along with the distance of the user's vehicle 14 from the second destination, to calculate the charge required to complete that journey.

This is achieved by the second computer device in the vehicle transmitting the present charge of the battery to the first computer device. This information is then used on the first computer device to calculate the remaining charge (Qt) in the battery on arrival at the booked charging station,

$$Qt = Qc - Qd ,$$

where, Qt=remaining charge on arrival
Qc=charge in battery at present
Qd=charge when arriving at charging station.

Secondly, from the calculation of the remaining charge on arrival to the charging station, the additional charge required to reach the second destination can be acquired, Qs=Qt+Qe,
where, Qs=charge required to reach second destination
Qt=remaining charge on arrival
Qe=additional charge from booked charging station.

This information is transmitted to the third computer device in the server and by additionally using the location of the vehicle a list of nearby charging stations can be found and presented to the user when necessary.

Once a user has left their first destination the battery status on the vehicle is continually checked (steps s10 and s11) to ensure the vehicle can reach the second destination. This is especially important if the user is diverted from their original journey or there are delays.

If the user is diverted or otherwise delayed and the charge in the battery depletes the user is presented with a list of charging stations that are available nearby (step s12). At this stage the user has a choice to book one of the charging stations offered in the list or to continue on route (step s13). If the user accidentally chooses “no” when asked if they would like to book, they are given a second chance to book (step s14), however the user can decline for a second time to book a charging station.

If the user agrees and books a new charging station the vehicle is rerouted to this new destination (step 15). This loop between checking the charge in the battery and ensuring there is enough charge to the reach the second destination (steps s10-s17) is continued until the user has finished their journey (step s18).

A similar example of the method the present invention will now be described. The apparatus, three computer devices and vehicle are the same and the journey to a first and then a second destination are also the same. On first use of the system, the user enters a first destination and optionally enters a second destination. If no second destination is entered, a return journey to the starting point is assumed as the second destination. The user selects an intended arrival time at which point the parking of the vehicle at the charging point in the vicinity of the first destination will begin. Alternatively, an intended departure time or immediate departure is selected which allows and estimated arrival time to be calculated based on journey length, speed limits, typical journey time and traffic conditions. The user is also prompted to enter an intended duration to their stay at the first destination. If a duration is not entered then an assumption can be made based on factors including but not limited to, previous visits to the same destination by the user or typical/average visits to the same destination by other users.

The distance of the journey to the first destination and traffic conditions allows an estimate of the charge required for the user's vehicle to travel to the first destination. The second computer, on the vehicle, transmits to the server (the third computer) the current charge in the vehicle. When the estimated charge required for the journey to the first destination is subtracted from the current charge, this gives an estimate of the remaining charge upon arrival at the first destination.

A further estimation can be made of the charge required to get from a charging station located in the vicinity of the first destination to a charging station in the vicinity of the second destination. This can be used to make a further estimation of how much charge will need to be added to the vehicle's battery to give it sufficient charge to safely make the journey to the second destination. The charge remaining on arrival at the first destination plus the charge that can be added must be greater than the charge required to get from the first destination to the second destination.

The server generates a list of chargers that are located in the vicinity of the destination.

The amount of charge that can be added to the vehicle's battery is dependent on the duration of the charge, the battery type and the charger type. Since the battery type and duration are known the third computer can therefore determine whether each of the chargers in the list can supply enough charge to replenish the battery to give sufficient charge for the vehicle to make the journey to the second destination.

The server communicates a list of items to the user's mobile computer device, the items representing charging stations which will be available at the arrival time and which can provide sufficient charge, as described above, to complete the journey from the first destination to the second destination. This list is displayed on the mobile computer device, including a list of prices for the charge and parking time, and the user can then select from the displayed list an item to book that charging station. Further journeys to further destinations can also be added if desired.

During the journey it is possible that more charge is required to get to the first destination. For example, traffic conditions could become worse slowing the journey or an accident may result in the vehicle following a diversion. If the charge in the vehicle on arrival at the first destination is significantly less than was estimated, the charge available from the charger in the time of the parking at the charging station near the first destination may be insufficient for the journey to the second destination.

If this is the case, the user can be alerted on their mobile device and an alternative list of charging stations can be displayed. This alternative list is of charging station which can provide sufficient charge to charge the battery from the charge remaining in the battery on arrival at the first destination, as currently re-estimated, to have sufficient charge to make the journey to the second destination. This list may include charging stations not in the previous list such as charging stations which will now be free because the user will arrive later at their destination and charging stations that are further away from the first destination. The user is given the option to change their booking to one of the charging stations in the alternative list.

Another aspect of the present invention will now be described which can be operated separately or in addition to the aspect set out above. The initial steps of selecting a destination and time of arrival, together with default options, are undertaken as set out above. However, an additional step is included where a conditional discount is added to the cost of the parking and charging. For example, if the user selects a particular business, such as a shop or a restaurant, that business can offer to discount the cost of the parking and charging. This discount could be a part or all of the cost of the parking and charging as estimated for the intended duration of parking. By way of specific example, if a restaurant is selected as the destination the restaurant can offer to discount part or all of the cost of the parking and charging on condition that a minimum amount is spent on a meal at the restaurant. If the user agrees to this discount by selecting the item from the list, as previously described, they are then obliged to undertake that minimum spend in order to receive the discount. If the minimum spend is not achieved then the discount is not applied and the standard charge for parking and charging will be applied to the user.

The same principle can be applied even if the destination selected is not a specific business wishing to offer a discount. For example, if a user is intending to drive to a shopping centre and will be using the electrical vehicle charging stations within the shopping centre car park then restaurants or shops within the shopping centre can offer to pay for all or part of the charging of the vehicle in return for a minimum spend with that business. This allows the businesses to bid against each other offering different discounts to the user. For example, one business may offer to pay for part of the cost of parking and charging in return for a particular amount being spent with that business whereas another business may offer to pay for all of the cost of parking in return for a larger amount being spent with them.

A further type of charging station presented in the list that the user could select (step s6) is an auction style charging station. Following the same procedure as before (steps s1-s6), the user has a more detailed list of the charging stations available. This list includes charging stations that are at a premium due to their proximity to a range of services, such as a city centre. This type of booking enables the user to either pay a premium fee and book the charging station in advance or to enter into a bid against other users. A user may be able to obtain the charging station at a lower price than the initial advance fee.

A further embodiment of the present invention utilises a vehicle battery's ability to supply charge back into an electricity supply network. In this embodiment a profile, that is a digital signature containing information about a vehicle's charge requirements for a certain period of time, is generated and communicated to a charging station to allow the charging station to make decisions about whether to add charge to or remove charge from the vehicle's battery.

The first stage of this process is to determine the journey plan for the electrically powered vehicle which will include a parking event at a commercial parking location, that is somewhere other than a domestic charging point. For example, a commercial parking location can include, but is not limited to, a car park with electrical charging points, such as a private car park or a state run or local government administered car park which makes a commercial charge for use of parking places or in a further example on street parking where a commercial charge is for parking in that location and a vehicle charging point is available. The process for determining the journey plan, as previously described, can include one or more planned steps which are selected as locations which a driver wishes to visit and which are entered into a user controlled device, such as a mobile phone, or a user input device in the vehicle. The journey plan can be a single journey, that is from one location to another or a multipart journey with multiple parking locations some or all of which include charging stations. Furthermore, the determination of the journey can be based on previous journeys or activities which are routinely undertaken. For example, typical working patterns can be used to determine that on a normal working day a journey is undertaken from home to work, that the vehicle will remain parked at work for a predictable length of time and the only other journey will be to return home along a known route or along one of a number of known roots. Once a journey plan has been determined this information can be used to calculate or estimate the charge required for the vehicle to complete the journeys in that plan.

Once the likely charge required in order to undertake the journey plan has been determined the available charge in the vehicle is also determined. This is generally achieved by receiving a signal from the vehicle's battery management system. Next a minimum allowable charge available in the vehicle is determined. This can be a set figure for the vehicle but can vary depending upon other factors. For example, some drivers may feel more vulnerable than others and do not wish, under any circumstances, to be left with no charge available in their vehicle. However, other drivers may feel more confident about their ability to manage the charge in a vehicle even in the event of unexpected traffic problems on a journey and may therefore be comfortable with a lower level of minimum charge remaining in their battery at the end of their journey plan. This minimum charge required may also vary by day and be based on previously undertaken journeys. For example, where a vehicle is primarily used for journeys from home to work and back on standard working days then a very low minimum allowable charge might be appropriate. However, it may be that on one day of the week the vehicle is used again shortly after returning home, where there is insufficient time to add significant charge to the vehicle, and this pattern of behaviour is therefore be used to vary the minimum allowable charge for that day of the week. The profile can include further information, including but not limited to, the Vehicle Identification Number (VIN), vehicle registration and a driver identifier.

These factors of charge required, charge available and minimum allowable charge are used together to generate a profile for the vehicle. As explained below, the profile may include further data in addition to those minimum requirements. When the vehicle is located at a commercial parking location and is connected to a charging point or charging station this profile data can be used to determine whether charge should be added to the battery or drawn from the battery. For example, charge can be drawn from the battery when the vehicle is parked at a commercial parking location at times of particularly high electrical demand on the electrical supply network, that is to respond to requests from electrical network suppliers to reduce demand or to supply electricity into the network, known as grid balancing. If the profile communicated to the charging station at the commercial parking location indicates that sufficient charges available and that the user is prepared to allow charge to be taken, then charge in the vehicle can be supplied back to the electrical supply network. The operator of the commercial parking location will be paid for making the charge available to the electrical network and all or part of this payment can be made available to the vehicle or rather the owner or driver of the vehicle. This can either be in the form of a direct repayment or a discount on the charge for parking.

The profile can include data relating to an automatic trigger. For example, this can mean that, assuming sufficient charge is available within the vehicle battery bearing in mind the charge required in order to complete the journey plan, that charge can be taken from the battery automatically. However, as an alternative, a communication may be made to the driver of the vehicle seeking permission to draw the charge from the battery. This is achieved by alerting the driver to the possibility of money back via and alert signal sent to an app running on the driver's mobile device (phone). This event takes place after the vehicle has parked and if the driver confirms that they are happy for the charge to be drawn from the battery leaving them sufficient charge to complete the planned journeys then the charge is taken from the battery and the discount is applied to their parking cost or a refund is made.

It will be appreciated by persons skilled in the art that the above embodiments have been described by way of example only and not in any limitative sense, and that various alterations and modifications are possible without departure from the scope of the protection which is defined by the appended claims. For example, the second computer in the vehicle could be used to transmit the status of the battery directly to the third computer in the server.

1. A method for booking an electrical charging station for an electric vehicle comprising the steps:
on a user interface a user selecting a first destination;
locating an electrical charging station in a vicinity of said first destination;
determining an estimated arrival time for an electric vehicle associate with said user at said charging station;
determining a duration for said vehicle to be charging at said charging station;
presenting to said user a first list of items representing said charging stations together with prices for use;
said user selecting an item to book a said charging station associated with said selected item;
determining a second destination;
estimating the remaining charge in said battery on arrival at said booked charging station;
evaluating the additional charge that could be supplied by the charging station to the vehicle over said duration;
calculating the total charge from the additional and remaining charges and determining whether the vehicle would have sufficient charge to travel to said second destination;
if the total charge is not sufficient presenting a second list of items representing said charging stations which can supply sufficient charge to the vehicle within the duration to power said vehicle to said second destination together with prices for use to said user; and
giving the user an option to alter the booked charging station.

2. The method according to claim 1, wherein determining an estimated arrival time comprises at least one of user entering a destination and calculating the arrival time by receiving positional information of said electrical vehicle.

3. The method according to claim 1 wherein said method operates on a system in which said user operates a first computer device, said vehicle comprises a second computer device and a server comprises a third computer device.

4. The method according to claim 3 wherein, determining the status of the battery comprises said first computer device receiving battery status information from said second computer device and transmitting data relating to said status information to said third computer device.

5. The method according to claim 1 wherein, determining the second destination comprises at least one of the user entering a second destination and assuming a return journey as a default.

6. The method according to claim 1 wherein, estimating the remaining charge in said battery on arrival at said charging station is estimated by subtracting from the charge in the battery an estimation of the charge required to get to said first destination.

7. A method for booking an electrical charging station for an electric vehicle comprising the steps:
on a user interface a user selecting a first destination;
estimating a first charge requirement this being the charge required to move the electric vehicle from its current location to a first charging station in the vicinity of the first destination based on a calculated route between the location and the first charging station;
determining a second destination;
estimating a second charge requirement this being the charge required to move the electric vehicle from the first charging station to a second charging station in the vicinity of the second destination based on a calculated route between the first charging station and the second charging station;
determining an estimated arrival time for an electric vehicle associate with the user at the charging station;
determining a duration for the vehicle to be charging at the first charging station;
determining the charge in a battery of the vehicle at the current location;
estimating the first remaining charge, this being the likely charge on arrival at the first destination by subtracting the first charge requirement from the charge in a battery of the vehicle at the current location;
estimating the added charge required, this being the charge which must be added to the battery, on top of the first remaining charge, for the vehicle to travel from the first charging station to the second charging station;
presenting to the user a first list of items representing a plurality of the first charging stations in the vicinity of the first destination which can provide the added charge required within the duration together with prices for use; and
the user selecting an item from the list of items to book the charging station associated with the selected item.

8. A method according to claim 7, wherein determining said duration comprises making estimates based on previous stays related to said first destination by said user and/or other users.

9. A method according to claim 7, wherein determining said second destination comprises assuming a return journey from said first destination.

10. A method for booking an electrical charger for an electric vehicle comprising the steps:
on a user interface a user selecting a destination;
locating an electrical charging station in the vicinity of said destination;
determining an estimated arrival time for an electric vehicle associated with the user at said charging station;
presenting a list of items representing said charging stations together with prices for use to said user, wherein said list includes at least one item conditionally discounted by a third party; and
said user selecting an item to book said charging station.

11. A method according to claim 10, wherein prior to presenting the list of items, the user is prompted to indicate the purpose of the trip they are undertaking.

12. A method for booking an electrical charger for an electric vehicle comprising the steps:
on a user interface a user selecting a destination;
locating an electrical charging station in the vicinity of said destination;
determining an estimated arrival time for an electric vehicle associated with the user at said charging station;
presenting a list of items representing said charging stations together with prices for use to said user, wherein said list includes at least one item with an option for the user to purchase the use of the associated charging station or to bid on said use against other users; and
said user selecting whether to purchase or bid.

13. A method of managing electrical vehicle battery charging at a commercial parking location, the method comprising:
determining at least one journey plan for an electrically powered vehicle with a battery including a parking event at a charging point;
using said journey plan to determine a charge required for said vehicle to complete said journey plan;
determining a charge available in said battery;
determining a minimum allowable charge for said battery;
using said charge required, said charge available and said minimum allowable charge to generate a profile for said vehicle;
communicating to a processor associated with said charging point said profile for said vehicle; and
adding charge to or drawing charge from the battery of the vehicle via said charging point dependent upon the profile.

14. A method according to claim 13, wherein said journey plan is determined by input of at least one destination by a user.

15. A method according to claim 13, wherein said journey plan is determined by analysis of previous journeys and travel patterns.

16. A method according to claim 13, wherein said journey plan includes a plurality of journeys to a plurality of charging stations.

17. A method according to claim 13, further comprising determining a driver identity for a driver of said vehicle and varying said minimum allowable charge dependent on said driver identity.

18. A method according to claim 13, further comprising determining vehicle identification data and including said vehicle identification data in said profile.

19. A method of managing electrical vehicle battery charging at a commercial parking location, the method comprising:
determining at least one journey plan including a journey from a charging point at a commercial parking location, where a cost for parking is payable, to a charging point at a variable cost charging location;
determining the charge required for making the or each journey;
determining the charge available in the vehicle;
varying the cost for parking in return for drawing some of the charge available in the vehicle.

20. A method according to claim 19, further comprising seeking confirmation from a user before varying the cost.

21. A method according to claim 19, wherein said journey plan is determined by input of at least one destination by a user.

22. A method according to claim 19, wherein said journey plan is determined by analysis of previous journeys and travel patterns.

23. A method according to claim 19, wherein said journey plan includes a plurality of journeys to a plurality of charging stations.

24. A method of managing electrical vehicle battery charging at a parking location, the method comprising:
determining at least one journey plan for an electrically powered vehicle with a battery including a parking event at a charging point;
using said journey plan, together with other data, to generate a profile;
communicating to a processor associated with said charging point said profile for said vehicle; and
adding charge to or drawing charge from the battery of the vehicle dependent upon the profile.
